(19) United States
(12) Patent Application Publication
(10) Pub. No.: US 2026/0218524 A1
(43) Pub. Date: Jul. 30, 2026

(54) PLASTIC COMPOSITE PANEL FOR FLOOR PROTECTION

(71) Applicants: HUESKER SYNTHETIC GMBH, Gescher (DE); W8SVR GMBH, Gescher (DE)

(72) Inventors: Oliver DETERT, Muelheim (DE); Leon NEFF, Bocholt (DE); Barbara SOLZBACHER, Emsdetten (DE); Johannes TERHECHTE, Stadtlohn (DE)

(21) Appl. No.: 19/463,557

(22) Filed: Jan. 29, 2026

(30) Foreign Application Priority Data
Jan. 29, 2025 (DE) 10 2025 103 198.3

(51) Int. Cl. E04F 15/10; B29C 43/20; B29C 43/30; B29K 23/00; B29K 105/08; B29L 31/00; B32B 3/06; B32B 3/14; B32B 5/02; B32B 5/12; B32B 7/08; B32B 27/12; B32B 27/20; B32B 27/32

(52) U.S. Cl. CPC E04F 15/107; B32B 3/06; B32B 3/14; B32B 5/024; B32B 5/026; B32B 5/12; B32B 7/08; B32B 27/12; B32B 27/20; B32B 27/32; B29C 43/203; B29C 43/305; B29K 2023/00; B29K 2105/0836; B29K 2105/0845; B29L 2031/732; B32B 2250/05; B32B 2305/70; B32B 2307/584; B32B 2471/00

(57) ABSTRACT

The invention relates to a plastic composite panel (10) for floor protection to prevent weight-related floor damage, comprising a plastic core layer (12), at least one upper-sided fiber composite layer (14b) arranged above the plastic core layer (12), at least one upper-sided plastic protective layer (16b) arranged above the upper-sided fiber composite layer (14b), at least one lower-sided fiber composite layer (14a) arranged below the plastic core layer (12), and at least one lower-sided plastic protective layer (16a) arranged below the lower-sided fiber composite layer (14a).

The invention relates to a plastic composite panel for floor protection to prevent weight-related floor damage, a panel arrangement with several plastic composite panels that can be connected to one another, and a method for manufacturing a plastic composite panel.

In a variety of work situations, it is necessary to protect floor area, for example driveways or work areas or work surfaces, from weight-related floor damage. Such floor damage can be caused, for example, by heavy vehicles, such as construction vehicles, or temporarily parked loads.

The protective panels used can, for example, protect existing driveways or make unstable floor areas drivable. Since the panels used usually have to distribute comparatively high loads, steel panels are regularly used for floor protection in the prior art. The steel panels are usually transported to the site by truck and laid out in the area of the floor to be protected. Due to the high weight of the steel panels, the transport, installation and removal of the steel panels is very costly and resource-intensive.

The task underlying the invention is therefore to reduce the effort and resources required for floor protection using load distribution panels.

The task is solved by a plastic composite panel of the type mentioned at the beginning, wherein the plastic composite panel according to the invention has a plastic core layer, at least one upper-sided fiber composite layer, at least one upper-sided plastic protective layer, at least one lower-sided fiber composite layer, and at least one lower-sided plastic protective layer. The at least one upper-sided fiber composite layer is arranged above the plastic core layer. The at least one upper-sided plastic protective layer is arranged above the upper-sided fiber composite layer. The at least one lower-sided fiber composite layer is arranged below the plastic core layer. The at least one lower-sided plastic protective layer is arranged below the lower-sided fiber composite layer.

The plastic composite panel can be used as a driveway panel or for creating work surfaces. The plastic composite panel increases load-bearing capacity and can therefore be used to set up temporary construction roads or to protect existing road areas. The plastic composite panel serves to distribute loads in order to increase the load-bearing capacity of the underground, making the underground drivable for an intended vehicle. The plastic composite panel reduces the load on the floor by reducing floor pressure, as the load is distributed over a larger area. The local pressure is reduced, but the pressure force applied by the vehicles is the same as when driving over without a plastic composite panel. The plastic composite panel is significantly lighter than a steel panel and is therefore easier to transport. This means that significantly more plastic composite panels than steel panels can be transported by truck, thereby considerably reducing transport effort. Overall, the use of the plastic composite panels according to the invention also results in lower maintenance costs than with steel panels, as there is no or only extremely rare plastic deformation. Deformed steel panels often have to be bent back at great effort. In addition, the plastic composite panels have no residual value at the end of their service life, which reduces the risk of theft compared to steel panels. The plastic composite panel allows a panel area of 500 to 1000 m² to be transported per truck, which means that the panel area that can be transported per truck is approximately five times larger than with conventional steel panels.

The layer structure of the plastic composite panel can be symmetrical below and above the plastic core layer. The upper-sided plastic protective layer and the lower-sided plastic protective layer can serve as a wear layer or sacrificial layer. Similarly, the upper-sided and lower-sided plastic layers can be used to emboss, mill, or otherwise process a structure or logo in order to achieve sufficient roughness or personalization.

The at least one upper-sided fiber composite layer and/or the at least one lower-sided fiber composite layer preferably comprises a matrix material, preferably a matrix plastic, in addition to fibers. The matrix material fixes the fibers and preferably also ensures a good bond to the plastic. The matrix material can also serve as a filler and/or adhesive between the fibers. The matrix material may correspond to the plastic material of the plastic core layer and/or the plastic material of the upper-sided plastic protective layer and/or the plastic material of the lower-sided plastic protective layer.

In a preferred embodiment of the plastic composite panel according to the invention, the plastic core layer has a greater layer thickness than the upper-sided plastic protective layer and/or the lower-sided plastic protective layer. The plastic core layer can have a layer thickness of at least 5 mm, preferably a layer thickness of at least 8 mm, and particularly preferably a layer thickness of at least 10 mm. The plastic core layer may have a layer thickness in a range between 5 mm and 50 mm, preferably a layer thickness in a range between 8 mm and 40 mm, particularly preferably a layer thickness in a range between 10 mm and 30 mm. The upper-sided plastic protective layer and/or the lower-sided plastic protective layer may have a layer thickness of 2 mm or more.

The plastic composite panel according to the invention is further advantageously developed in that the plastic core layer and/or the at least one upper-sided plastic protective layer and/or the at least one lower-sided plastic protective layer comprises one or more virgin plastics and/or one or more recycled plastics. The plastic composite panel can thus be manufactured in an environmentally friendly manner, so that the operational area is extended to applications in which a certain degree of environmental friendliness is required or preferred.

In a further preferred embodiment of the plastic composite panel according to the invention, the plastic core layer and/or the at least one upper-sided plastic protective layer and/or the at least one lower-sided plastic protective layer is formed from a thermoplastic. The thermoplastic may be a polyolefin. The thermoplastic may be a polyethylene, for example a high-density polyethylene (HDPE) such as PE300, or a high-molecular-weight polyethylene (PE-HMW) such as PE500, or an ultra-high-molecular-weight polyethylene (PE-UHMW), in particular PE1000, or a mixture of HDPE, HMW, or UHMW. The thermoplastic may be a polypropylene. The thermoplastic may be a polyester, for example a polyethylene terephthalate (PET).

In a further preferred embodiment of the plastic composite panel according to the invention, the plastic core layer and/or the at least one upper-sided plastic protective layer and/or the at least one lower-sided plastic protective layer is formed as a plastic melt layer based on regrind and/or cut material. The regrind or cut material used may comprise powder, flakes, or even coarser materials.

Alternatively or additionally, the plastic core layer and/or the at least one upper-sided plastic protective layer and/or the at least one lower-sided plastic protective layer is formed as an agglomerate-based plastic melt layer. Alternatively or additionally, the plastic core layer and/or the at least one upper-sided plastic protective layer and/or the at least one lower-sided plastic protective layer is formed as a granulate-based plastic melt layer.

Furthermore, a plastic composite panel according to the invention is advantageous in which fibers are embedded in the plastic core layer and/or in the at least one upper-sided plastic protective layer and/or in the at least one lower-sided plastic protective layer. The embedded fibers provide greater strength and stability to the plastic layers, further increasing the load-bearing capacity of the plastic composite panel.

Furthermore, a plastic composite panel according to the invention is advantageous in which the fibers embedded in the plastic core layer and/or the fibers embedded in the at least one upper-sided plastic protective layer and/or the fibers embedded in the at least one lower-sided plastic protective layer are individual fibers, in particular scattered individual fibers, or form a fiber mat. The embedded fibers can be introduced by means of a premixed plastic-fiber mixture. The embedded fibers can be introduced by means of separate fiber scattering. The embedded fibers can be introduced as a fiber mat, for example as pile, fleece, or consolidated fleece fabric. By introducing fibers into one or both plastic protective layers, material shrinkage during the manufacturing process can be reduced or prevented entirely.

Material shrinkage is undesirable in the manufacturing process. Material shrinkage, in particular different material shrinkage of the layers, can lead to warping of the plastic composite panel or to delamination of the individual layers. The low-shrinkage plastic composite panel has better layer bonding and thus significantly increased strength.

In another preferred embodiment of the plastic composite panel according to the invention, the fibers embedded in the plastic core layer and/or the fibers embedded in the at least one upper-sided plastic protective layer and/or the fibers embedded in the at least one lower-sided plastic protective layer comprise mineral fibers and/or synthetic fibers and/or carbon fibers and/or natural fibers. The mineral fibers may comprise glass fibers and/or basalt fibers. The synthetic fibers may comprise aramid fibers. The natural fibers may comprise flax fibers and/or hemp fibers and/or sisal fibers and/or jute fibers and/or coconut fibers.

In a further embodiment of the plastic composite panel according to the invention, one or more filling materials are introduced into the plastic core layer and/or into the at least one upper-sided plastic protective layer and/or into the at least one lower-sided plastic protective layer. One or more mineral filling materials, such as calcium carbonate, sand, aluminum hydroxide, talc, broken glass, glass balls, and/or glass fibers, may be incorporated. One or more polymeric filling materials may be incorporated. One or more natural or organic filling materials, such as natural fibers, for example hemp fibers, flax fibers, and/or carbon blacks, may be incorporated. The one or more filling materials may be introduced in an unconsolidated form, for example as loose fibers, or as a fiber pile or fleece. The one or more filling materials may be introduced as consolidated fleece fabrics, for example as thermally consolidated and/or mechanically consolidated and/or chemically consolidated fleece fabrics. The one or more filling materials may be incorporated as woven fabrics, scrim fabric, knitted fabrics, or grids.

Furthermore, a plastic composite panel according to the invention is preferred in which the at least one upper-sided fiber composite layer and/or the at least one lower-sided fiber composite layer comprise only one or multiple textile layers. The at least one upper-sided fiber composite layer and/or the at least one lower-sided fiber composite layer may have two to ten textile layers, preferably two to eight textile layers, particularly preferably two to six textile layers. The at least one upper-sided fiber composite layer and/or the at least one lower-sided fiber composite layer may comprise individual fibers and/or fiber scraps and/or fiber mat pieces. If the at least one upper-sided fiber composite layer or the at least one lower-sided fiber composite layer comprise several textile layers, the fibers of the respective textile layers may have different orientation directions relative to one another. For example, the orientation directions of the fibers of the respective textile layers differ by 90 degrees or by 45 degrees or by 30 degrees or by another orientation difference angle between 15 degrees and 280 degrees from each other.

Furthermore, a plastic composite panel according to the invention is advantageous in which the at least one upper-sided fiber composite layer and/or the at least one lower-sided fiber composite layer comprises mineral fibers and/or synthetic fibers and/or carbon fibers. The mineral fibers may comprise glass fibers and/or basalt fibers. The synthetic fibers may be aramid fibers. The plastic composite panel can be a roadway panel with glass fiber reinforcement and a sacrificial layer. The fiber reinforcement allows the material thickness to be reduced while maintaining the same load-bearing capacity, so that the plastic composite panel has a lower weight compared to conventional PE panels. The stiffness achieved by the fiber reinforcement enables optimum passability on soft floor. The load from vehicle tires is distributed over a larger area by the panel. Depending on requirements, the panel structure can also be modified to withstand greater loads.

Furthermore, a plastic composite panel according to the invention is preferred in which the at least one upper-sided fiber composite layer and/or the at least one lower-sided fiber composite layer have fibers which are present as a cohort or form a textile surface composite. If the fibers are present as a cohort, the fibers are oriented next to each other. The fibers can be present in particular in the form of woven fabrics, scrim fabrics, knitted fabrics, grids, a thread cohort, or similar structures. The fibers can be present in particular as woven fabric in a plain weave with a 1/1 twill. The knitted fabrics can be glass fiber knitted fabrics which are connected, for example, by sewing with binding thread or sewing thread-typically tricot, fringe, or cloth, or a combination of the aforementioned stitch types. The textile composite can be open or closed. In the case of an open textile composite, the flowable plastic can flow through the textile surface composite during the manufacture of the plastic composite panel, so that a strong and resilient bond is created.

The plastic composite panel according to the invention is further advantageously developed in that the at least one upper-sided fiber composite layer and/or the at least one lower-sided fiber composite layer have unidirectionally and/or multidirectionally oriented fibers. The at least one upper-sided fiber composite layer and/or the at least one lower-sided fiber composite layer can be formed, for example, by a unidirectional fiber mat. Alternatively, the fibers of the at least one upper-sided fiber composite layer and/or the at least one lower-sided fiber composite layer can be present at right angles to each other, as in a woven fabric or knitted fabric.

Furthermore, a plastic composite panel according to the invention is preferred in which the at least one upper-sided fiber composite layer and/or the at least one lower-sided fiber composite layer comprise impregnated fibers. The impregnation may consist predominantly of the plastic of the plastic core layer and/or the at least one upper-sided plastic protective layer and/or the at least one lower-sided plastic protective layer or a plastic compatible therewith. The fibers can be impregnated directly. The impregnation can be a pre-impregnation. Alternatively or additionally, a thread cohort and/or a textile surface can be formed during the manufacture of the plastic composite panel, wherein the thread cohort and/or the textile surface is then subsequently impregnated.

In a further preferred embodiment of the plastic composite panel according to the invention, the at least one upper-sided fiber composite layer and/or the at least one lower-sided fiber composite layer comprise one or more woven fabric layers and/or one or more knitted fabric layers. The woven fabric or knitted fabric of the one or more woven layers and/or knitted layers can be made of thermoplastic, spread, thermoplastic-coated glass fibers. Furthermore, the one or more woven layers and/or knitted layers can be formed by a prepreg, in particular a prepreg woven fabric or prepreg knitted fabric or powdered woven fabric or knitted fabric.

In a further preferred embodiment of the plastic composite panel according to the invention, the at least one upper-sided fiber composite layer and/or the at least one lower-sided fiber composite layer have one or more fiber-reinforced ribbons. The ribbons can also be referred to as tapes, so that the fibers consequently form one or more fiber tapes. The fiber tapes preferably consist of fibers, in particular continuous fibers, which are laid flat in a parallel alignment with each other and are preferably pre-impregnated. In this context, “continuous” means that the fibers in the yarn have only one beginning and one end and have no interruptions in the yarn, as is the case with staple fibers. Yarns made of continuous fibers are, for example, glass fiber rovings, filament yarns, in particular monofilament yarns or multifilament yarns, little ribbons or splice yarns or tapes made of several flat laid (continuous) filaments. The fiber tapes can form, for example, one or more woven fabrics, one or more knitted fabrics, one or more scrim fabrics and/or one or more grids. The fiber tapes can, in particular, form a woven fabric in a plain weave with a 1/1 twill. Several fiber-reinforced tapes can form a ribbon arrangement. The ribbon arrangement can be open or closed. An open ribbon arrangement allows the flowable plastic to flow through the ribbon arrangement during the manufacture of the plastic composite panel, thus forming a strong bond. The ribbon arrangement may, for example, be or comprise a woven fabric, a knitted fabric, a scrim fabric, and/or a grid. The tape ribbon arrangement may, for example, be a glass fiber tape woven fabric, a glass fiber tape knitted fabric, a glass fiber tape scrim fabric, or a glass fiber tape grid.

In a further preferred embodiment of the plastic composite panel, the at least one upper-sided plastic protective layer and/or the at least one lower-sided plastic protective layer comprises a mixture of plastic and scattered glass fibers or hollow glass spheres.

In a further embodiment of the plastic composite panel according to the invention, the outer side of the at least one upper-sided plastic protective layer and/or the outer side of the at least one lower-sided plastic protective layer is thermally, mechanically, and/or chemically treated. For example, the outer side of the at least one lower-sided plastic protective layer and/or the outer side of the at least one upper-sided plastic protective layer is roughened and/or machined. Thermal treating may include calendering or embossing. Machining may include milling, planing, grinding, or brushing. The surface may be reworked by pressing. Reworking may be used, for example, to enable better passability due to increased friction between the plastic composite panel and a vehicle. As an alternative to the roughened and/or thermally or machined surface, an additional friction-modifying layer may be applied. In particular, a friction-modifying layer may comprise a coating. The surface reduces the risk of slipping and increases friction. Furthermore, sand or grit can be scattered onto the surface and then pressed in. The scattered glass fibers can have a length between 2 and 75 mm.

In a further embodiment of the plastic composite panel according to the invention, the outer side of the at least one upper-sided plastic protective layer and/or the outer side of the at least one lower-sided plastic protective layer has a rib-like and/or line-like structure and/or a knob-like and/or grid-like structure. In particular, the surface may have a diagonally ribbed structure in which so-called ripples, piles, or snags, which comprise rib-shaped elevations/depressions, protrude from the surface. The arrangement of the ripples may be diagonally offset from one another. Several ripples may also be arranged parallel to one another, thus resulting in a so-called rippling. The surface may be cut. Applications may be present on the surface, for example, glued and/or welded coatings.

Furthermore, a plastic composite panel according to the invention is preferred in which the reinforcing fibers of the fiber-reinforced ribbons have a unidirectional fiber alignment. The fiber-reinforced tapes are therefore so-called unidirectional tapes (UD tapes). The reinforcing fibers of the fiber-reinforced ribbons preferably have a straight and twist-free fiber orientation, so that the force absorption in the component is further optimized.

The plastic composite panel according to the invention is further advantageously developed in that the fiber-reinforced ribbons of the at least one upper-sided fiber composite layer and/or the at least one lower-sided fiber composite layer form a woven ribbon fabric. The woven ribbon fabric comprises several fiber-reinforced ribbons woven together. The reinforcing fibers of a first group of ribbons preferably extends in a first direction. The reinforcing fibers of a second group of ribbons preferably extends in a second direction. The first and second direction differ from each other and run, in particular, at right angles to each other. The fiber-reinforced ribbons can also form a plain weave.

The plastic composite panel according to the invention is further advantageously designed in that an outer-sided fiber-free material strip is located in the frame region of the plastic composite panel. The outer-sided fiber-free material strip can have a width in the range of 5 mm to 200 mm, preferably a width in the range between 5 mm and 100 mm. The outer-sided fiber-free material strip prevents fibers from protruding from the plastic composite panel in the frame region, even if the material shrinks during manufacture. In addition, the outer-sided fiber-free material strip can be machined so that, for example, a machined panel edge, such as a chamfered panel edge, can be provided in the frame region.

In another preferred embodiment of the plastic composite panel according to the invention, a fiber-free material strip is located in a region of the plastic composite panel distant from the panel edge. The fiber-free material strip located distant from the panel edge interrupts the fiber composite layers. The fiber-free material strip located distant from the panel edge enables targeted deformability of the plastic composite panel and thus greater panel flexibility. The fiber composite layers of the plastic composite panel may be interrupted in several regions. The interrupted regions of the at least one upper-sided fiber composite layer and the at least one lower-sided fiber composite layer may be offset or aligned.

The task underlying the invention is further solved by a panel arrangement of the type mentioned at the beginning, wherein the plastic composite panels of the panel arrangement according to the invention are designed according to one of the embodiments described above. With regard to the advantages and modifications of the panel arrangement according to the invention, reference is therefore first made to the advantages and modifications of the plastic composite panel according to the invention.

The several plastic composite panels of the plate arrangement according to the invention can be connected directly to each other, i.e., without a separate connecting element. Alternatively, the several plastic composite panels can be connected to each other using a connecting element. The several plastic composite panels can preferably be connected to each other in a form-fitting and/or force-fitting manner. Plastic composite panels connected to each other are secured against shifting and slipping to a greater extent than individual panels.

In a preferred embodiment of the panel arrangement according to the invention, the several plastic composite panels can be connected to one another by plugging and form a plug-in system. Preferably, the plastic composite panels have a plug-in contour in the frame region or in the edge region, via which the plastic composite panels can be plugged together. If the plastic composite panels can be connected to each other via a separate connecting element, the connecting element can be a plug-in element via which two or more than two plastic composite panels can be plugged together.

In another preferred embodiment of the panel arrangement according to the invention, the several plastic composite panels can be connected to one another by screw connections. Several plastic composite panels can be screwed together directly by one or more screws or by a screw nut connection. Alternatively, the plastic composite panels can be connected to each other by screwing to a connecting element. The connecting element may be an element that is bending resistant in relation to the plastic composite panel, such as a steel part, or an element that is flexible in relation to the plastic composite panel, such as a plastic part, in particular an injection-molded part or a textile.

The task underlying the invention is further solved by a method for manufacturing a plastic composite panel according to one of the embodiments described above, wherein the plastic composite panel is manufactured in a pressing process or in an extrusion process. With regard to the advantages and modifications of the method according to the invention, reference is first made to the advantages and modifications of the plastic composite panel according to the invention.

In a preferred embodiment of the method according to the invention, a sintering press or a belt press is used in the pressing process. Sintering presses can be used to produce solid components from powdered starting materials under pressure and temperature. The individual powder particles bond together to form a solid material. The belt press can be a double belt press. A double belt press enables the continuous manufacture of plastic composite panels. The double belt press can be an isobaric double belt press, an isochoric double belt press, or a combined isobaric/isochoric double belt press. The isobaric double belt press works with a pressure medium that is held in a pressure chamber between a pressure plate and a press belt and provides uniform pressure distribution. In the isochoric double belt press, the pressure is transmitted mechanically to the pressing belts via rollers.

In a preferred embodiment of the method according to the invention, when using a sintering press, one or more of the following steps are performed: introducing plastic material for the at least one lower-sided plastic protective layer into a workpiece carrier, introducing fiber material for the at least one lower-sided fiber composite layer into the workpiece carrier, introducing plastic material for the plastic core layer into the workpiece carrier, introducing fiber material for the at least one upper-sided fiber composite layer into the workpiece carrier, introducing plastic material for the at least one upper-sided plastic protective layer into the workpiece carrier, compressing the introduced plastic material and/or the introduced fiber material by means of a pressure stamp, warming the compressed plastic material, in particular to melt the plastic material.

During the manufacture of the plastic composite panel, plastic material and fiber material are preferably introduced into the workpiece carrier alternately. The workpiece carrier can be a formwork. The introduced plastic material can be fiber-free or comprise fibers, for example glass fibers, i.e., be a plastic-fiber mixture. Alternatively, the introduced plastic material can be a plastic-filling material mixture. After the plastic material has been introduced, the plastic material can be raked or otherwise homogenized. The fiber material can be introduced by inlaying fiber layers. The pressure stamp preferably exerts a constant pressure over the entire surface of the subsequent plastic composite panel. A predetermined temperature is preferably set to warm the pressed plastic material. Preferably, the temperature of a heat transfer medium is set, e.g., a medium that is introduced to heat the heating elements. The flow temperature can thus be above the melting temperature of the plastic, for example approximately 30 to 70° C. above the melting temperature of the plastic. After the plastic material has melted, a cooling takes place before the workpiece carrier is removed from the sintering press and the plastic composite panel is released from the workpiece carrier.

In a further preferred embodiment of the method according to the invention, when using a belt press, one or more of the following steps are performed: positioning a panel blank comprising plastic material and fiber material between pressing belts of the belt press, compressing the panel blank between the pressing belts of the belt press, warming the panel blank between the pressing belts of the belt press, in particular to melt the plastic material, controlled cooling of the panel blank, in particular between the pressing belts of the belt press, after melting the plastic material. The warming of the panel blank and the pressing of the panel blank can be carried out simultaneously.

The plastic composite panel can also be manufactured using an extrusion process. In discontinuous manufacture, the panel is extruded by pressing the molten plastic into a prefabricated mold. The fiber material can be introduced into the mold before the casting process, for example by being inlayed, and enclosed by the molten plastic. In continuous manufacture, the molten plastic is extruded from a wide slot nozzle. In this case, the fiber material can be pressed while being soft. The plastic composite panel is then cut from the cooled, continuously extruded plastic composite.

Preferred embodiments of the invention are explained and described in more detail below with reference to the accompanying drawings. These show:

FIG. 1 a plastic composite panel according to the invention in a schematic cross-sectional view;

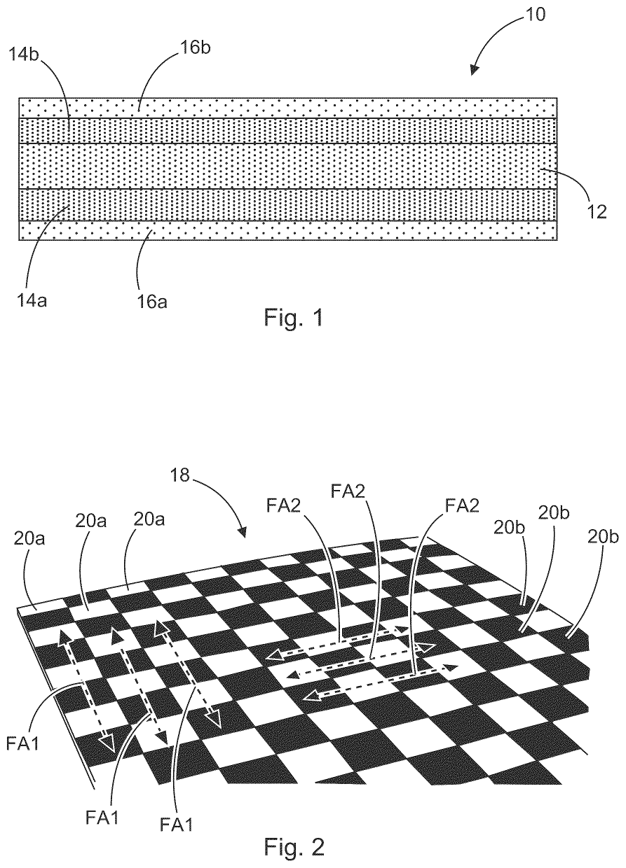

FIG. 2 a textile layer of a plastic composite panel according to the invention in a schematic perspective view;

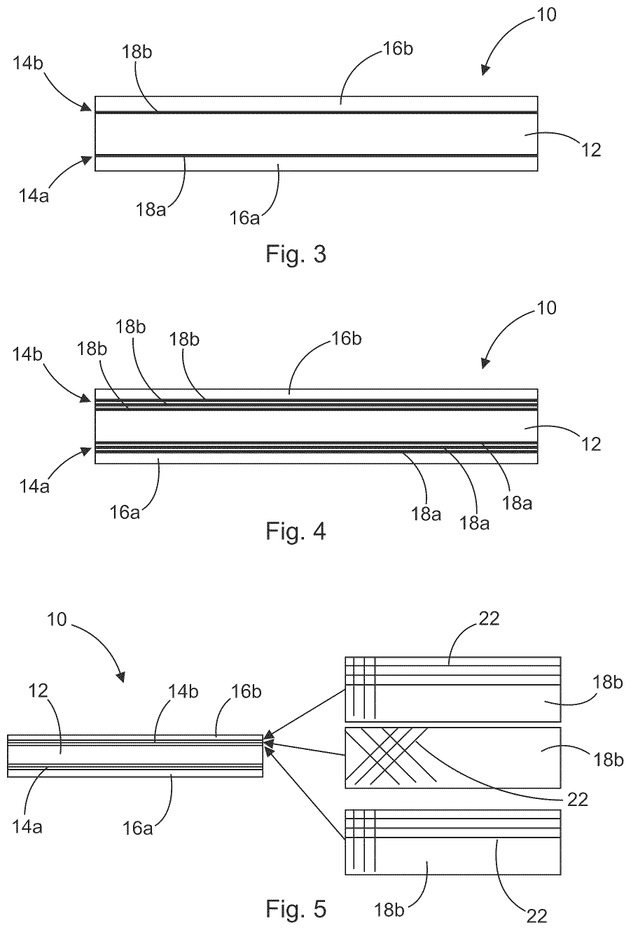

FIG. 3 a plastic composite panel according to the invention with fiber composite layers each having a textile layer in a schematic cross-sectional view;

FIG. 4 a plastic composite panel according to the invention with fiber composite layers each having three textile layers in a schematic cross-sectional view;

FIG. 5 another plastic composite panel according to the invention in a schematic cross-sectional view and the orientations of the fibers of the textile layers;

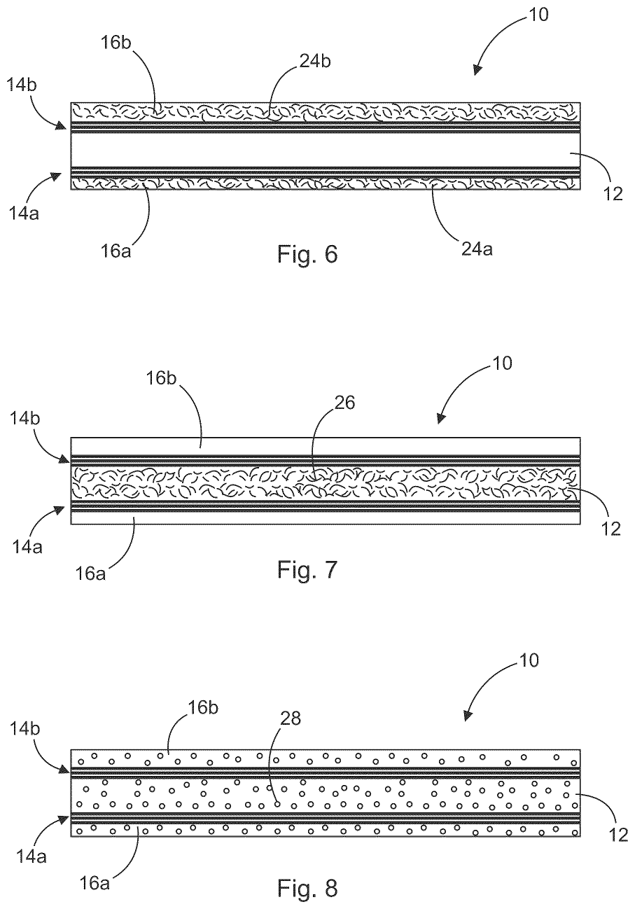

FIG. 6 a plastic composite panel according to the invention with fiber composite layers each having three textile layers and plastic protective layers comprising fibers in a schematic cross-sectional view;

FIG. 7 a plastic composite panel according to the invention with fiber composite layers each having three textile layers and a plastic core layer comprising fibers in a schematic cross-sectional view;

FIG. 8 a plastic composite panel according to the invention with fiber composite layers each having three textile layers and plastic layers comprising a filling material, shown in a schematic cross-sectional view;

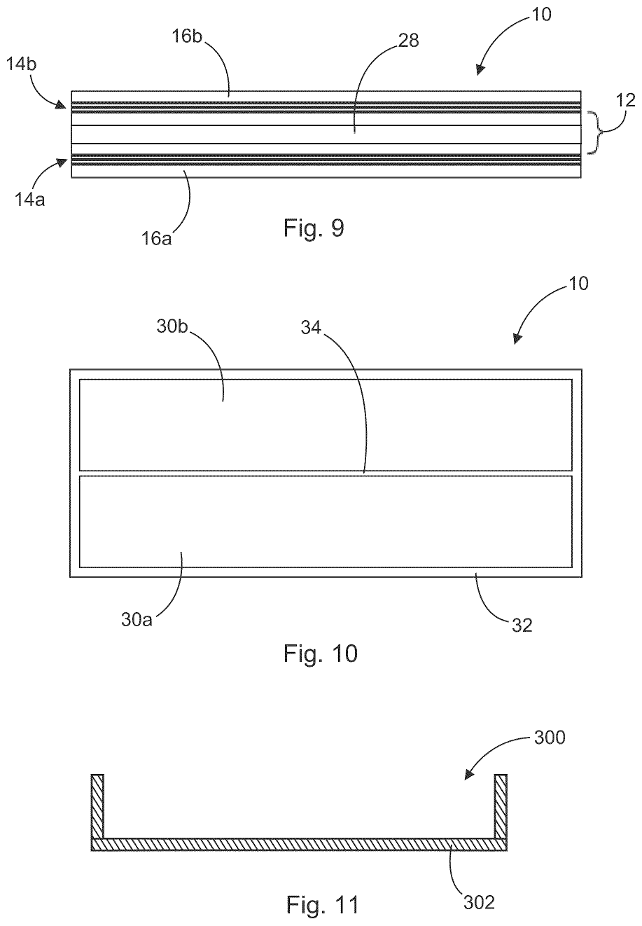

FIG. 9 a plastic composite panel according to the invention with fiber composite layers each having three textile layers and a plastic core layer comprising a filling material in a schematic cross-sectional view;

FIG. 10 another plastic composite panel according to the invention in a schematic top view;

FIG. 11 the workpiece carrier of a sintering press at the beginning of the manufacture of a plastic composite panel in a schematic view;

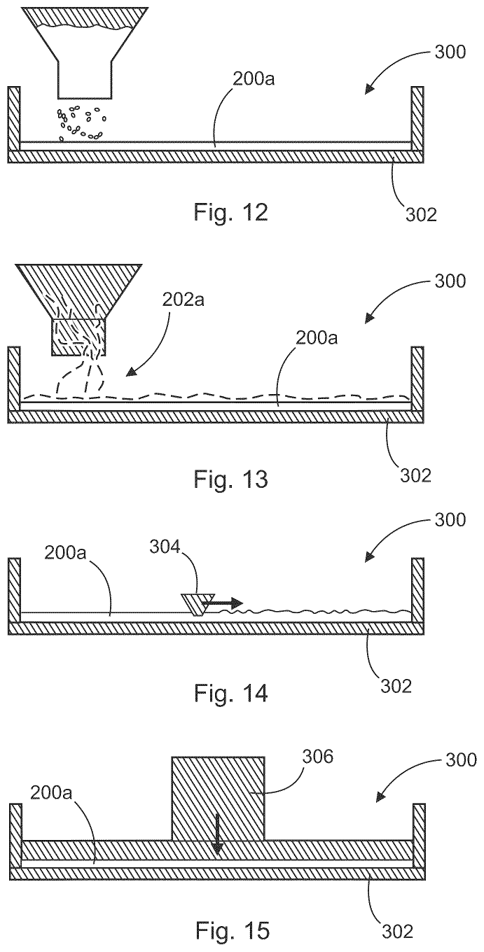

FIG. 12 the workpiece carrier shown in FIG. 11 during the introduction of plastic material in a schematic view;

FIG. 13 the workpiece carrier shown in FIG. 12 during the introduction of fiber material in a schematic view;

FIG. 14 the workpiece carrier shown in FIG. 13 during the homogenization of the introduced plastic material in a schematic view;

FIG. 15 the workpiece carrier shown in FIG. 14 during the compression of the homogenized plastic material in a schematic view;

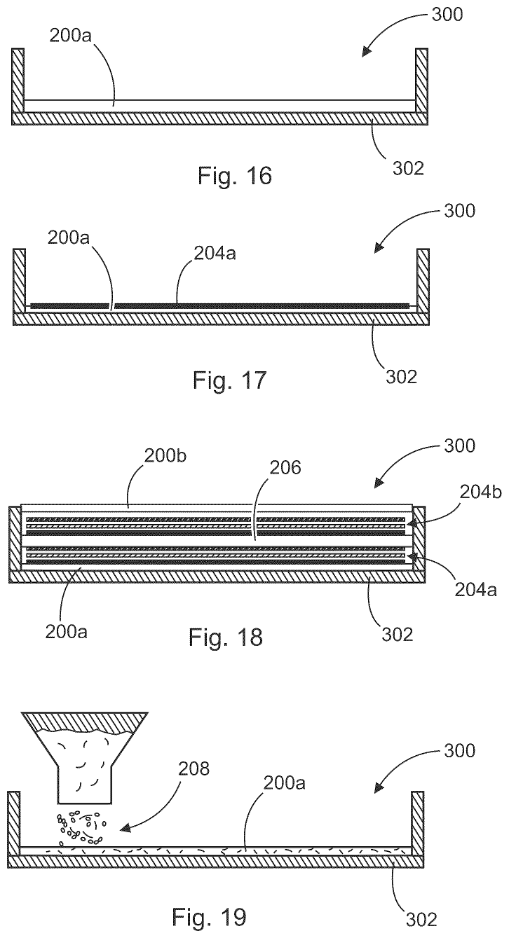

FIG. 16 the workpiece carrier shown in FIG. 15 with homogenized and compressed plastic material in a schematic view;

FIG. 17 the workpiece carrier shown in FIG. 16 after the introduction of a textile layer in a schematic view;

FIG. 18 the workpiece carrier shown in FIG. 17 after the introduction of further textile layers and further plastic material in a schematic view;

FIG. 19 the workpiece carrier shown in FIG. 11 during the introduction of a plastic-fiber mixture in a schematic view;

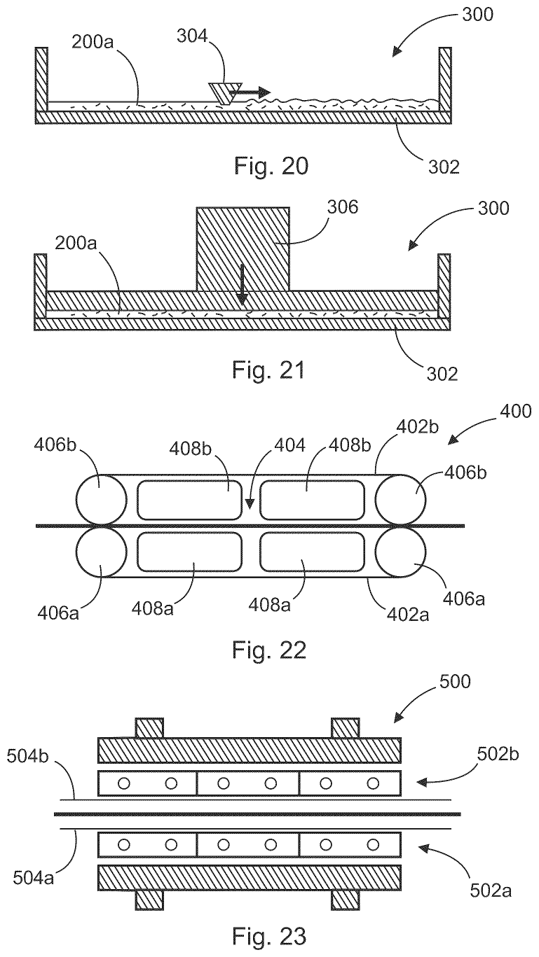

FIG. 20 the workpiece carrier shown in FIG. 19 during the homogenization of the introduced plastic-fiber mixture in a schematic view;

FIG. 21 the workpiece carrier shown in FIG. 20 during the compression of the homogenized plastic-fiber mixture in a schematic view;

FIG. 22 a belt press for manufacturing a plastic composite panel according to the invention in a schematic view; and

FIG. 23 a further press for manufacturing a plastic composite panel according to the invention in a schematic view.

FIG. 1 shows a plastic composite panel 10 with a multi-layer structure. The plastic composite panel 10 is a roadway panel which can be used for floor protection to prevent weight-related floor damage.

The plastic composite panel 10 comprises a plastic core layer 12, a lower-sided fiber composite layer 14a, an upper-sided fiber composite layer 14b, a lower-sided plastic protective layer 16a, and an upper-sided plastic protective layer 16b. The lower-sided fiber composite layer 14a is arranged below the plastic core layer 12. The lower-sided plastic protective layer 16a is arranged below the lower-sided fiber composite layer 14a. The upper-sided fiber composite layer 14b is arranged above the plastic core layer 12. The upper-sided plastic protective layer 16b is arranged above the upper-sided fiber composite layer 14b.

The plastic core layer 12 has a greater layer thickness than the lower-sided plastic protective layer 16a and the upper-sided plastic protective layer 16b. The plastic core layer 12 has a layer thickness in a range between 5 and 50 mm. The lower-sided plastic protective layer 16a and the upper-sided plastic protective layer 16b have a layer thickness of more than 2 mm. The plastic core layer 12, the lower-sided plastic protective layer 16a, and the upper-sided plastic protective layer 16b are thermoplastics and are plastic melt layers based on regrind.

The lower-sided fiber composite layer 14a and the upper-sided fiber composite layer 14b may comprise one or more textile layers 18, 18a, 18b.

FIG. 2 shows an example of such a textile layer 18. The textile layer 18 shown is a woven fabric layer consisting of several fiber-reinforced ribbons 20a, 20b woven together. The reinforcing fibers of the fiber-reinforced ribbons 20a, 20b each have a unidirectional fiber alignment FA1, FA2. The ribbon fabric formed by the fiber-reinforced ribbons 20a, 20b has a first group of ribbons 20a and a second group of ribbons 20b. The reinforcing fibers of the first group of ribbons extend in a first direction FA1. The reinforcing fibers of the second group of ribbons 20b extend in a second direction FA2. The first and second directions FA1, FA2 run at right angles to each other.

The fibers of the ribbons 22a, 22b are glass fibers, so that the ribbon fabric is a glass fiber tape fabric.

The textile layer 18 can alternatively be a knitted fabric layer of warp threads, weft threads, and binding threads.

FIG. 3 shows a plastic composite panel 10 in which the fiber composite layers 14a, 14b each have only one textile layer 18a, 18b. The fibers of the textile layers 18a, 18b can be mineral fibers, synthetic fibers or carbon fibers. The textile layers 18a, 18b can be woven fabric layers, scrim fabric layers, knitted layers, grid layers, or thread bundle layers. The layer structure below and above the plastic core layer 12 is symmetrical.

FIG. 4 shows a plastic composite panel 10 in which the fiber composite layers 14a, 14b each have three textile layers 18a, 18b. The textile layers 18a, 18b can be textile layers of the same type or different types. The textile layers 18a of the fiber composite layer 14a lie directly on top of each other. The textile layers 18b of the fiber composite layer 14b lie directly on top of each other.

FIG. 5 shows that the textile layers 18b of the fiber composite layer 14b can have different fiber orientations. The orientation of the fibers 22 of adjacent textile layers 18b differs by 45° in each case.

FIG. 6 shows a plastic composite panel 10 in which fibers 24a, 24b are embedded in the lower-sided plastic protective layer 16a and the upper-sided plastic protective layer 16b. The fibers 24a embedded in the lower-sided plastic protective layer 16a and the fibers 24b embedded in the upper-sided plastic protective layer 16b are scattered individual fibers. The embedded fibers 24a, 24b can be introduced by a premixed plastic-fiber mixture during the manufacturing process of the plastic composite panel 10. Alternatively, the embedded fibers 24a, 24b can be introduced by separate fiber scattering during the manufacture of the plastic composite panel 10. The fibers 24a, 24b embedded in the lower-sided plastic protective layer 16a and the upper-sided plastic protective layer 16b can be mineral fibers, synthetic fibers, carbon fibers, or natural fibers.

FIG. 7 shows a plastic composite panel 10 in which fibers 26 are embedded in the plastic core layer 12. The fibers 26 embedded in the plastic core layer 12 are scattered individual fibers. The fibers 26 embedded in the plastic core layer 12 can be mineral fibers, synthetic fibers, carbon fibers or natural fibers.

FIG. 8 shows a plastic composite panel in which a filling material 28 is introduced into the plastic core layer 12 and the lower-sided plastic protective layer 16a and the upper-sided plastic protective layer 16b. The filling material 28 can be a mineral filling material, such as calcium carbonate, sand, aluminum hydroxide or glass fiber spheres. Alternatively, the filling material 28 can also be a polymeric or natural or organic filling material.

In the embodiment shown in FIG. 9, a filling material 28 is only introduced into the plastic core layer 12. In this case, the filling material 28 is already consolidated and can be, for example, a consolidated fleece fabric. The consolidated filling material 28 can be, for example, a thermally and/or mechanically and/or chemically consolidated fleece fabric. Alternatively, the filling material 28 can also be a woven fabric, a scrim fabric, a knitted fabric, or a grid.

FIG. 10 shows a plastic composite panel 10 in which the fiber composite layers 14a, 14b have several, in this case two, fiber composite strips 30a, 30b lying next to each other in the same plane. An outer-sided, fiber-free material strip 32 is located in the frame region of the plastic composite panel 10. A fiber-free material strip 34 is located between the fiber composite strips 30a, 30b, which runs along a region of the plastic composite panel 10 distant from the panel edge.

The outer-sided free material strip 32 can have a width in the range of 5 to 200 mm. Due to the outer-sided fiber-free material strip 32, no fibers protrude from the plastic composite panel 10 in the frame region. In addition, the outer-sided free material strip can be machined so that, for example, a machined chamfer can be provided in the frame region.

The fiber-free material strip 34, which is arranged away from the panel edge, interrupts the fiber structure of the fiber composite layers 14a, 14b within the panel. The fiber-free material strip 34, which is arranged distant from the panel edge, achieves a targeted deformability of the plastic composite panel 10 and thus a higher panel flexibility.

FIGS. 11 to 21 show the manufacture of a plastic composite panel 10 using a sintering press 300.

As shown in FIG. 11, the sintering press 300 has a workpiece carrier 302 which serves to hold the plate material.

As shown in FIG. 12, plastic material 200a for a lower-sided plastic protective layer 16a is first introduced into the workpiece carrier 302. The plastic material 200a can be plastic regrind or plastic cuttings, for example in the form of powder, flocks, flakes, or other forms.

As shown in FIG. 13, fiber material 202a can optionally be placed on and in the plastic material 200a.

FIG. 14 shows that the introduced plastic material 200a is then evenly distributed in the workpiece carrier 302 by means of a doctor blade 304. If, as shown in FIG. 13, supplementary fiber material 202a has been introduced into the workpiece carrier 302, the plastic-fiber material mixture is homogenized by means of the doctor blade 304.

FIG. 15 shows that, after homogenization, a pressure stamp 306 can be used to compress and consolidate the plastic material layer 200a. However, single-layer compression is not absolutely necessary, depending on the intended plate properties.

FIG. 16 shows the homogenized and compressed layer of plastic material 200a.

As shown in FIG. 17, the fiber material 204a for the lower-sided fiber composite layer 14a can then be inserted into the workpiece carrier 302. The fiber material 204a can be a textile layer, for example a woven fabric, a knitted fabric, or a fleece fabric.

The introduction of fiber material and plastic is then repeated depending on the intended panel configuration.

FIG. 18 shows a method state in which plastic material 200a for the lower-sided plastic protective layer 16a, fiber material 204a for the lower-sided fiber composite layer 14a, plastic material 206 for the plastic core layer 12, fiber material 204b for the upper-sided fiber composite layer 14b and plastic material 200b for the upper-sided plastic protective layer 16b has been introduced into the workpiece carrier 302. After the compression of the plastic material 200a, 200b, 206 and the fiber material 204a, 204b, the plastic material is melted by adding heat. After heating, the desired temperature is maintained for a predetermined process duration before the plastic composite panel 10 can be cooled and removed from the workpiece carrier 302.

FIG. 19 shows that the plastic material 200a for the plastic protective layer 16a can already be introduced into the workpiece carrier 302 in the form of a plastic-fiber mixture 208.

As shown in FIGS. 20 and 21, in this case, the plastic-fiber mixture 208 is homogenized using a doctor blade 304 and compressed using a pressure stamp 306.

FIG. 22 shows a double belt press 400 for manufacturing a plastic composite panel 10. The double belt press 400 comprises two circumferential pressing belts 402a, 402b, wherein a transport gap 404 is located between the pressing belts 402a, 402b. The pressing belt 402a is guided by the deflection rollers 406a. The pressing belt 402b is guided by the deflection rollers 406b. Between the pressing belts 402a, 402b is located a reaction zone in which a pre-placed panel blank is subjected to pressure and heat treatment. For this purpose, the double belt press 400 is equipped with one or more pressure devices and/or temperature devices 408a, 408b, which can exert a pressing force on the panel blank via the pressing belts 402a, 402b.

The panel blank is first positioned between the pressing belts 402a, 402b. As soon as the pressing belts 402a, 402b close, pressure is applied to the panel blank while heat is simultaneously applied. The plastic material of the panel blank is softened in the reaction zone by heating. The pressure is continuously increased at the inlet of the belt press 400 to remove air and gas pockets from the panel blank, thus preventing air pockets between the layers. The softening until the plastic melts causes the layers and any additives to bond together. The escape of air and gases and the shaping of the press modules create a massive, uniform soft mass. In one embodiment, active cooling may be provided in the rear part of the double belt press. The cooling can be provided by an active temperature control device, for example, an active cooling device. The panel blank is therefore moved through a heating zone and a cooling zone during the manufacturing process. The cooling gradually reduces the temperature, thereby reducing stresses in the material. This prevents unintentional stress-induced bending of the plastic composite panels 10. The plastic composite is continuously conveyed out of the double belt press 400 and then cut into plastic composite panels 10 in a cutting unit. The panel surface can be modified during or after the panel pressing process.

FIG. 23 shows another press 500, by means of which plastic composite panels 10 according to the invention can be manufactured. The press 500 has sliding plates 502a, 502b, on which slide belts 504a, 504b are guided to move the panel blank. The reaction zone is located between the slide belts 504a, 504b.

Reference mark

| | |
|---|---|
| 10 | Plastic composite panel |
| 12 | Plastic core layer |
| 14a, 14b | Fiber composite layers |
| 16a, 16b | Plastic protective layers |
| 18, 18a, 18b | Textile layers |
| 20a, 20b | ribbons |
| 22 | fibers |
| 24a, 24b | fibers |
| 26 | fibers |
| 28 | filling material |
| 30a, 30b | Fiber composite strip |
| 32 | Fiber-free material strip |
| 34 | Fiber-free material strip |
| 200a, 200b | plastic material |
| 202a | fiber material |
| 204a, 204b | fiber material |
| 206 | plastic material |
| 208 | plastic-fiber mixture |
| 300 | sintering press |
| 302 | workpiece carrier |
| 304 | doctor blade |
| 306 | pressure stamp |
| 400 | belt press |
| 402a, 402b | pressing belts |
| 404 | transport gap |
| 406a, 406b | deflection rollers |
| 408a, 408b | pressure device |
| 500 | press |
| 502a, 502b | pressure plates |
| 504a, 504b | slide belts |
| FA1, FA2 | fiber alignments |

1. Plastic composite panel (10) for floor protection to prevent weight-related floor damage, comprising
a plastic core layer (12);
at least one upper-sided fiber composite layer (14b) arranged above the plastic core layer (12),
at least one upper-sided plastic protective layer (16b) arranged above the upper-sided fiber composite layer (14b),
at least one lower-sided fiber composite layer (14a) arranged below the plastic core layer (12), and
at least one lower-sided plastic protective layer (16a) arranged below the lower-sided fiber composite layer (14a).

2. Plastic composite panel (10) according to claim 1,
characterized in that the plastic core layer (12) has a greater layer thickness than the upper-sided plastic protective layer (16b) and/or the lower-sided plastic protective layer (16a).

3. Plastic composite panel (10) according to claim 1 or 2,
characterized in that the plastic core layer (12) and/or the at least one upper-sided plastic protective layer (16b) and/or the at least one lower-sided plastic protective layer (16a) comprises one or more virgin plastics and/or one or more recycled plastics.

4. Plastic composite panel (10) according to one of the preceding claims, characterized in that the plastic core layer (12) and/or the at least one upper-sided plastic protective layer (16b) and/or the at least one lower-sided plastic protective layer (16a) is formed from a thermoplastic.

5. Plastic composite panel (10) according to one of the preceding claims, characterized in that the plastic core layer (12) and/or the at least one upper-sided plastic protective layer (16b) and/or the at least one lower-sided plastic protective layer (16a) is formed as
a plastic melt layer based on regrind and/or cut material, and/or
an agglomerate-based plastic melt layer, and/or
a granulate-based plastic melt layer.

6. Plastic composite panel (10) according to one of the preceding claims, characterized in that fibers (24a, 24b, 26) are embedded in the plastic core layer (12) and/or in the at least one upper-sided plastic protective layer (16b) and/or in the at least one lower-sided plastic protective layer (16a).

7. Plastic composite panel (10) according to claim 6,
characterized in that the fibers (26) embedded in the plastic core layer (12) and/or the fibers (24b) embedded in the at least one upper-sided plastic protective layer (16b) and/or the fibers (24a) embedded in the at least one lower-sided plastic protective layer (16a) are individual fibers, in particular scattered individual fibers, or form a fiber mat.

8. Plastic composite panel (10) according to 6 or 7,
characterized in that the fibers (26) embedded in the plastic core layer (12) and/or the fibers (24b) embedded in the at least one upper-sided plastic protective layer (16b) and/or the fibers (24a) embedded in the at least one lower-sided plastic protective layer (16a) comprise
mineral fibers; and/or
synthetic fibers; and/or
carbon fibers; and/or
natural fibers.

9. Plastic composite panel (10) according to one of the preceding claims, characterized in that one or more filling materials (28) are introduced into the plastic core layer (12) and/or into the at least one upper-sided plastic protective layer (16b) and/or into the at least one lower-sided plastic protective layer (16a).

10. Plastic composite panel (10) according to one of the preceding claims, characterized in that the at least one upper-sided fiber composite layer (14b) and/or the at least one lower-sided fiber composite layer (14a) comprise only one or multiple textile layers (18, 18a, 18b).

11. Plastic composite panel (10) according to one of the preceding claims, characterized in that the at least one upper-sided fiber composite layer (14b) and/or the at least one lower-sided fiber composite layer (14a) comprises
mineral fibers (22); and/or
synthetic fibers; and/or
carbon fibers.

12. Plastic composite panel (10) according to one of the preceding claims, characterized in that the at least one upper-sided fiber composite layer (14b) and/or the at least one lower-sided fiber composite layer (14a) have fibers (22) which are present as a cohort or form a textile surface composite.

13. Plastic composite panel (10) according to one of the preceding claims, characterized in that the at least one upper-sided fiber composite layer (14b) and/or the at least one lower-sided fiber composite layer (14a) have unidirectionally and/or multidirectionally oriented fibers (22).

14. Plastic composite panel (10) according to one of the preceding claims, characterized in that the at least one upper-sided fiber composite layer (14b) and/or the at least one lower-sided fiber composite layer (14a) comprise impregnated fibers.

15. Plastic composite panel (10) according to one of the preceding claims, characterized in that the at least one upper-sided fiber composite layer (14b) and/or the at least one lower-sided fiber composite layer (14a) comprise one or more woven fabric layers and/or one or more knitted fabric layers.

16. Plastic composite panel (10) according to one of the preceding claims, characterized in that the at least one upper-sided fiber composite layer (14b) and/or the at least one lower-sided fiber composite layer (14a) have one or more fiber-reinforced ribbons (20a, 20b).

17. Plastic composite panel (10) according to claim 16, characterized in that the reinforcing fibers (22) of the fiber-reinforced ribbons (20a, 20b) have a unidirectional fiber alignment (FA1, FA2).

18. Plastic composite panel (10) according to claim 16 or 17, characterized in that the fiber-reinforced ribbons (20a, 20b) of the at least one upper-sided fiber composite layer (14b) and/or the at least one lower-sided fiber composite layer (14a) form a woven ribbon fabric.

19. Plastic composite panel (10) according to one of the preceding claims, characterized in that an outer-sided fiber-free material strip (32) is located in the frame region of the plastic composite panel (10).

20. Plastic composite panel (10) according to one of the preceding claims, characterized in that a fiber-free material strip (34) is located in a region of the plastic composite panel (10) distant from the panel edge.

21. Panel arrangement, with
several plastic composite panels (10) that can be connected to one another;
characterized in that the plastic composite panels (10) are designed according to one of the preceding claims.

22. Panel arrangement according to claim 21,
characterized in that the several plastic composite panels (10) can be connected to one another by plugging or by screw connections and form a plug-in system or a screw-connected system.

23. Method for manufacturing a plastic composite panel (10) according to one of claims 1 to 20,
characterized in that the plastic composite panel (10) is manufactured in a pressing process or in an extrusion process.

24. Method according to claim 23,
characterized in that a sintering press (300) or a belt press is used in the pressing process.

25. Method according to claim 24,
characterized in that, when using a sintering press (300), one or more of the following steps are performed:
introducing plastic material (200a) for the at least one lower-sided plastic protective layer (16a) into a workpiece carrier (302);
introducing fiber material (204a) for the at least one lower-sided fiber composite layer (14a) into the workpiece carrier (302);
introducing plastic material (206) for the plastic core layer (12) into the workpiece carrier (302);
introducing fiber material (204b) for the at least one upper-sided fiber composite layer (14b) into the workpiece carrier (302);
introducing plastic material (200b) for the at least one upper-sided plastic protective layer (16b) into the workpiece carrier (302);
compressing the introduced plastic material (200a, 200b, 206) and/or the introduced fiber material (204a, 204b) by means of a pressure stamp (306);
warming the compressed plastic material (200a, 200b, 206), in particular to melt the plastic material (200a, 200b, 206).

26. Method according to claim 24,
characterized in that, when using a belt press (400), one or more of the following steps are performed:
positioning a panel blank comprising plastic material (200a, 200b, 206) and fiber material (204a, 204b) between pressing belts (402a, 402b) of the belt press (400);
compressing the panel blank between the pressing belts (402a, 402b) of the belt press (400);
warming the panel blank between the pressing belts (402a, 402b) of the belt press (400), in particular to melt the plastic material (200a, 200b, 206);
controlled cooling of the panel blank, in particular between the pressing belts (402a, 402b) of the belt press (400), after melting the plastic material (200a, 200b, 206).
